(19) United States
(12) Patent Application Publication
(10) Pub. No.: US 2021/0325085 A1
(43) Pub. Date: Oct. 21, 2021

(54) MIXING VALVE WITH ANTI-SCALING FEATURES AND METHODS OF OPERATION

(71) Applicant: Haier US Appliance Solutions, Inc., Wilmington, DE (US)

(72) Inventors: Jonathan D. Nelson, Louisville, KY (US); Gregory L. Hutchison, Shelbyville, KY (US); Shaun Michael Ward, Louisville, KY (US); Timothy Scott Shaffer, La Grange, KY (US)

(21) Appl. No.: 16/851,241

(22) Filed: Apr. 17, 2020

(51) Int. Cl. F24H 9/00; F24H 9/12; F16K 1/32; F16K 29/02

(52) U.S. Cl. CPC F24H 9/0042; F16K 29/02; F16K 1/32; F24H 9/124

(57) ABSTRACT

A mixing valve for a water heater appliance includes a valve body that defines a mixing chamber, the mixing chamber being in fluid communication with a cold water inlet conduit and a hot water inlet conduit. A plunger valve is mounted within the valve body and is moveable along a translation axis to regulate a flow of water from the hot water inlet conduit and the cold water inlet conduit. A controller periodically initiates a cleaning cycle wherein the plunger valve is moved through a full range of motion (e.g., full hot to full cold). The cleaning cycle may only be performed if there is no water flowing through the mixing valve, e.g., as determined by temperature sensor measurements.

### FIELD OF THE INVENTION

The present subject matter relates generally to mixing valves for water heater appliances, and more particularly, to methods of operating mixing valves to reduce the build-up of scale or other deposits.

### BACKGROUND OF THE INVENTION

Certain water heater appliances include a tank therein. Heating elements, such as gas burners, electric resistance elements, or induction elements, heat water within the tank during operation of such water heater appliances. During operation, relatively cold water flows into the tank, and the heating elements operate to heat such water to a predetermined temperature. In particular, the heating elements generally heat water within the tank to a very high temperature. A mixing valve mixes the relatively hot water with relatively cold water in order to bring the temperature of such water down to suitable and/or more usable temperatures. For example, mixing valves may adjust the ratio of hot and cold water to supply heated water at an output temperature suitable for showering, washing hands, etc.

Conventional mixing valves include one or more plungers that regulate the flows of hot and/or cold water traveling through hot and cold inlet orifices, respectively. For example, the plunger may move into and out of the orifices to restrict and regulate a flow therethrough. However, such mixing valves are also prone to hard-water-scaling, where mineral deposits and contaminants may foul the internal surfaces of the valve. For example, hard-water-scaling of the internal surfaces, particularly O-ring sealing surfaces, results in loss of motion and/or function of the mixing valve. Alternatively, such O-rings may experience excessive wear, may fail altogether, may result in water leaks or valve failure, etc. As a result, conventional mixing valves have lower reliability, increased maintenance requirements, and lowered performance.

Accordingly, a mixing valve with improved performance and reliability would be useful. More specifically, a mixing valve with features for reducing scaling from hard water or build-up from other contaminants during operation would be particularly beneficial.

### BRIEF DESCRIPTION OF THE INVENTION

Advantages of the invention will be set forth in part in the following description, or may be apparent from the description, or may be learned through practice of the invention.

In one exemplary aspect of the present disclosure, a mixing valve for a water heater appliance is provided. The mixing valve includes a valve body that defines a mixing chamber, a hot water inlet conduit providing fluid communication between the mixing chamber and a hot water supply, a cold water inlet conduit providing fluid communication between the mixing chamber and a cold water supply, a plunger valve mounted within the valve body, the plunger valve being moveable along a translation axis to regulate the flow of water from the hot water inlet conduit and the cold water inlet conduit, and a drive motor operably coupled to the plunger valve for selectively moving the plunger valve. A controller is in operative communication with the drive motor and is configured for periodically initiating a cleaning cycle, wherein the cleaning cycle comprises moving the plunger valve through a full range of motion.

In another exemplary aspect of the present disclosure, a method of operating a mixing valve for a water heater appliance, the mixing valve including a plunger valve moveable along a translation axis to regulate a flow of water from a hot water inlet conduit and a cold water inlet conduit. The method includes periodically initiating a cleaning cycle, wherein the cleaning cycle comprises moving the plunger valve through a full range of motion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water heater appliance according to an exemplary embodiment of the present subject matter.

FIG. 2 provides a schematic view of certain components of a water heater system including the exemplary water heater appliance of FIG. 1 according to an exemplary embodiment of the present subject matter.

FIG. 3 provides a perspective view of a mixing valve for use with the exemplary water heater appliance of FIG. 1 according to an exemplary embodiment of the present subject matter.

FIG. 4 provides a cross sectional view of the exemplary mixing valve of FIG. 3 according to an exemplary embodiment of the present subject matter.

FIG. 5 provides a perspective, cross sectional view of the exemplary mixing valve of FIG. 3 according to an exemplary embodiment of the present subject matter.

FIG. 6 provides a close-up, cross sectional view of a plunger and an inlet orifice of the exemplary mixing valve of FIG. 3 according to an exemplary embodiment of the present subject matter.

FIG. 7 illustrates a method for operating a mixing valve to reduce scale build-up in accordance with one embodiment of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. In addition, as used herein, terms of approximation, such as “approximately,” “substantially,” or “about,” refer to being within a ten percent margin of error.

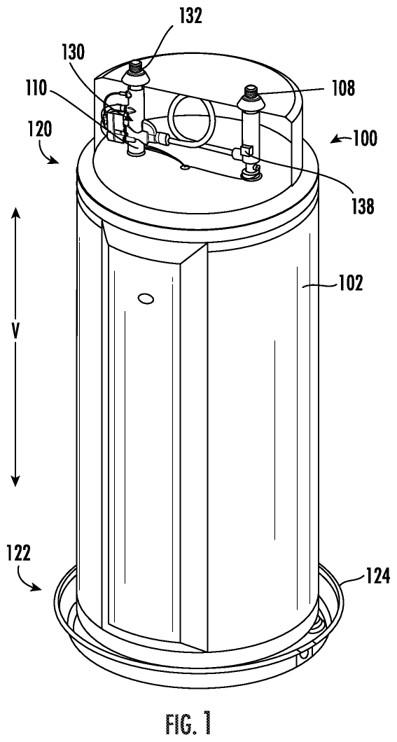

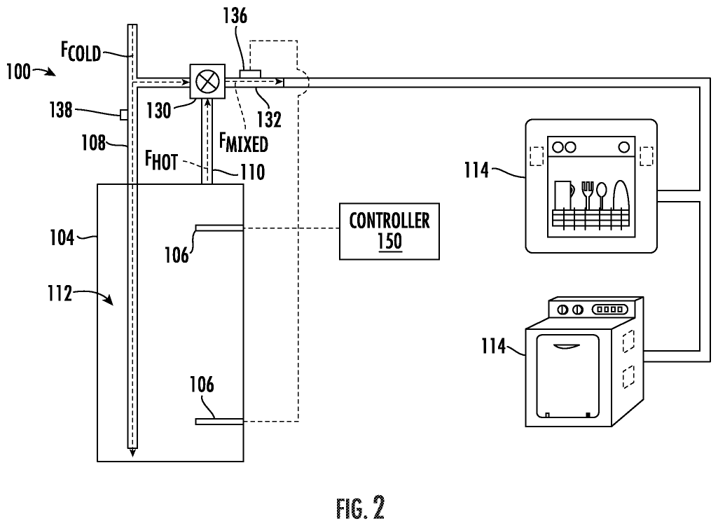

FIG. 1 provides a perspective view of a water heater appliance 100 according to an exemplary embodiment of the present subject matter. Water heater appliance 100 includes a casing 102. A tank 104 (FIG. 2) and heating elements 106 (FIG. 2) are positioned within casing 102 for heating water therein. Heating elements 106 may include a gas burner, a heat pump, an electric resistance element, a microwave element, an induction element, a sealed heat pump system or any other suitable heating element, heating assembly, or combination thereof. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water heater appliance 100 also includes a cold water supply 108 and a hot water supply 110 that are both in fluid communication with an interior volume or a chamber 112 (FIG. 2) defined by tank 104. As an example, cold water from a water source, e.g., a municipal water supply or a well, can enter water heater appliance 100 through cold water supply 108 (shown schematically with arrow labeled F_{cold} in FIG. 2). From cold water supply 108, such cold water can enter chamber 112 of tank 104 wherein it is heated with heating elements 106 to generate heated water. Such heated water can exit water heater appliance 100 at hot water supply 110 and, e.g., be supplied to a water consuming device 114 (FIG. 2). In this regard, water consuming devices 114 may include any suitable plumbing fixture, household appliance, or any other suitable device configured to draw water from water heater appliance 100, such as a bath, shower, sink, or any other suitable fixture. It should be appreciated that the terms “cold” and “hot” are only intended to refer to the relative temperatures of flows of water or to identify conduits transporting such flows. These terms are not intended to require that a particular conduit provide water at a specific temperature or within a specific temperature range.

Water heater appliance 100 extends longitudinally between a top portion 120 and a bottom portion 122 along a vertical direction V. Thus, water heater appliance 100 is generally vertically oriented. Water heater appliance 100 can be leveled, e.g., such that casing 102 is plumb in the vertical direction V, in order to facilitate proper operation of water heater appliance 100. A drain pan 124 is positioned at bottom portion 122 of water heater appliance 100 such that water heater appliance 100 sits on drain pan 124. Drain pan 124 sits beneath water heater appliance 100 along the vertical direction V, e.g., to collect water that leaks from water heater appliance 100. It should be understood that water heater appliance 100 is provided by way of example only and that the present subject matter may be used with any suitable water heater appliance.

FIG. 2 provides a schematic view of certain components of water heater appliance 100. As may be seen in FIG. 2, water heater appliance 100 includes a mixing valve 130 and a mixed water conduit 132. Mixing valve 130 is in fluid communication with cold water supply 108, hot water supply 110, and mixed water conduit 132. As discussed in greater detail below, mixing valve 130 is configured for selectively directing water from cold water supply 108 and hot water supply 110 into mixed water conduit 132 in order to regulate an output temperature of water within mixed water conduit 132.

As an example, mixing valve 130 can selectively adjust between a first position and a second position. In the first position, mixing valve 130 can permit a first flow rate of relatively cool water from cold water supply 108 (shown schematically with arrow labeled F_{cold} in FIG. 2) into mixed water conduit 132 and mixing valve 130 can also permit a first flow rate of relatively hot water from hot water supply 110 (shown schematically with arrow labeled Fₕₒₜ in FIG. 2) into mixed water conduit 132. In such a manner, water within mixed water conduit 132 (shown schematically with arrow labeled F_{mixed} in FIG. 2) can have a first particular temperature when mixing valve 130 is in the first position.

Similarly, mixing valve 130 can permit a second flow rate of relatively cool water from cold water supply 108 into mixed water conduit 132 and mixing valve 130 can also permit a second flow rate of relatively hot water from hot water supply 110 into mixed water conduit 132 in the second position. The first and second flow rates of the relatively cool water and relatively hot water are different such that water within mixed water conduit 132 can have a second particular temperature when mixing valve 130 is in the second position. In such a manner, mixing valve 130 can regulate the temperature of water within mixed water conduit 132 and adjust the temperature of water within mixed water conduit 132 between the first and second particular temperatures.

It should be understood that, in certain exemplary embodiments, mixing valve 130 is adjustable between more positions than the first and second positions. In particular, mixing valve 130 may be adjustable between any suitable number of positions in alternative exemplary embodiments. For example, mixing valve 130 may be infinitely adjustable in order to permit fine-tuning of the temperature of water within mixed water conduit 132. Mixing valve 130 may be an electronic mixing valve. In addition, mixing valve 130 may be positioned within casing 102, e.g., above tank 104. Thus, mixing valve 130 may be integrated within water heater appliance 100. According to still other exemplary embodiments, mixing valve 130 may be positioned remote from water heater appliance 100, e.g., proximate a water consuming device.

According to exemplary embodiments, water heater appliance 100 may use inlet and/or outlet temperature sensors to properly position mixing valve 130 to achieve the desired water temperature. According to alternative embodiments, water heater appliance 100 may include a position sensor that is configured for determining a position of mixing valve 130. The position sensor can monitor the position of mixing valve 130 in order to assist with regulating the temperature of water within mixed water conduit 132. For example, the position sensor can determine when mixing valve 130 is in the first position or the second position in order to ensure that mixing valve 130 is properly or suitably positioned depending upon the temperature of water within mixed water conduit 132 desired or selected. Thus, the position sensor can provide feedback regarding the status or position of mixing valve 130.

According to the illustrated exemplary embodiment, water heater appliance 100 includes a mixed water conduit flow detector or temperature sensor 136 for detecting a temperature of mixed water passing through mixed water conduit 132 and a cold water inlet temperature sensor 138 for measuring an inlet temperature of water in the cold water supply 108. According to alternative embodiments, water heater appliance may further includes a hot water supply flow detector or temperature sensor or any other suitable sensors for detecting the flow and/or temperature of water within water heater appliance 100.

Water heater appliance 100 further includes a controller 150 that is configured for regulating operation of water heater appliance 100. Controller 150 is in, e.g., operative communication with heating elements 106, mixing valve 130, and temperature sensor 136. Thus, controller 150 can selectively activate heating elements 106 in order to heat water within chamber 112 of tank 104. Similarly, controller 150 can selectively operate mixing valve 130 in order to adjust a position of mixing valve 130 and regulate a temperature of water within mixed water conduit 132.

Controller 150 includes memory and one or more processing devices such as microprocessors, CPUs or the like, such as general or special purpose microprocessors operable to execute programming instructions or micro-control code associated with operation of water heater appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 150 can be positioned at a variety of locations. In the exemplary embodiment shown in FIG. 1, controller 150 is positioned within water heater appliance 100, e.g., as an integral component of water heater appliance 100. In alternative exemplary embodiments, controller 150 may positioned away from water heater appliance 100 and communicate with water heater appliance 100 over a wireless connection or any other suitable connection, such as a wired connection.

Controller 150 can operate heating elements 106 to heat water within chamber 112 of tank 104. As an example, a user can select or establish a set-point temperature for water within chamber 112 of tank 104, or the set-point temperature for water within chamber 112 of tank 104 may be a default value. Based upon the set-point temperature for water within chamber 112 of tank 104, controller 150 can selectively activate heating elements 106 in order to heat water within chamber 112 of tank 104 to the set-point temperature for water within chamber 112 of tank 104. The set-point temperature for water within chamber 112 of tank 104 can be any suitable temperature. For example, the set-point temperature for water within chamber 112 of tank 104 may be between about one hundred and twenty degrees Fahrenheit and about one hundred and eighty-degrees Fahrenheit.

Controller 150 can also operate mixing valve 130 to regulate the temperature of water within mixed water conduit 132. For example, controller 150 can adjust the position of mixing valve 130 in order to regulate the temperature of water within mixed water conduit 132. As an example, a user can select or establish a predetermined target temperature of mixing valve 130, or the target temperature of mixing valve 130 may be a default value. The target temperature of mixing valve 130 can be any suitable temperature. For example, the target temperature of mixing valve 130 may be between about one hundred degrees Fahrenheit and about one hundred and twenty degrees Fahrenheit. In particular, the target temperature of mixing valve 130 may be selected such that the target temperature of mixing valve 130 is less than the set-point temperature for water within chamber 112 of tank 104.

Based upon the target temperature of mixing valve 130, controller 150 can adjust the position of mixing valve 130 in order to change or tweak a ratio of relatively cool water flowing into mixed water conduit 132 from cold water supply 108 and relatively hot water flowing into mixed water conduit 132 from hot water supply 110. More specifically, controller 150 can implement any suitable control strategy or algorithm to regulate the temperature of water within mixed water conduit 132. In such a manner, mixing valve 130 can utilize water from cold water supply 108 and hot water supply 110 to regulate the temperature of water within mixed water conduit 132.

Referring now generally to FIGS. 3 through 6, a mixing valve 200 for use with water heater appliance 100 will be described according to an exemplary embodiment of the present subject matter. For example, mixing valve 200 may be the same or similar to mixing valve 130 described above. Although mixing valve 200 is described herein as being used with water heater appliance 100, it should be appreciated that aspects of the present subject matter may be used in any other water heater appliance, in any other mixing valve, or in any other application where it is desirable to regulate a flow of water through an orifice. The exemplary embodiment described herein is only exemplary and is not intended to limit the scope of the present subject matter.

As illustrated, mixing valve 200 includes a valve body 202 that defines an internal volume or mixing chamber 204. In general, mixing chamber 204 is in fluid communication with hot water supply 110 to receive a flow of hot water and cold water supply 108 to receive a flow of cold water. The flow of hot water and the flow of cold water mix within mixing chamber 204 and are discharged downstream through mixed water conduit 132 (e.g., to one or more water consuming devices 114). More specifically, mixing valve 200 may include one or more inlet conduits that are fluidly coupled to or formed as part of valve body 202. In this regard, according to the illustrated embodiment, mixing valve 200 includes a hot water inlet conduit 206 that provides fluid communication between mixing chamber 204 and a hot water supply (e.g., such as hot water supply 110 or interior volume 112 through a direct connection) and a cold water inlet conduit 208 that provides fluid communication between mixing chamber 204 and a cold water supply (e.g., such as cold water supply 108). In this manner, mixing chamber 204 may be supplied with both hot and cold flows of water.

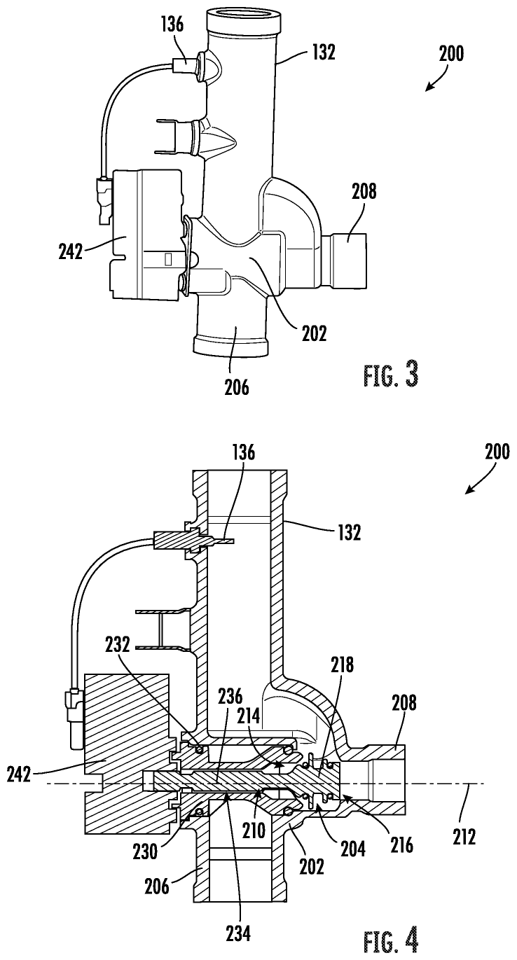

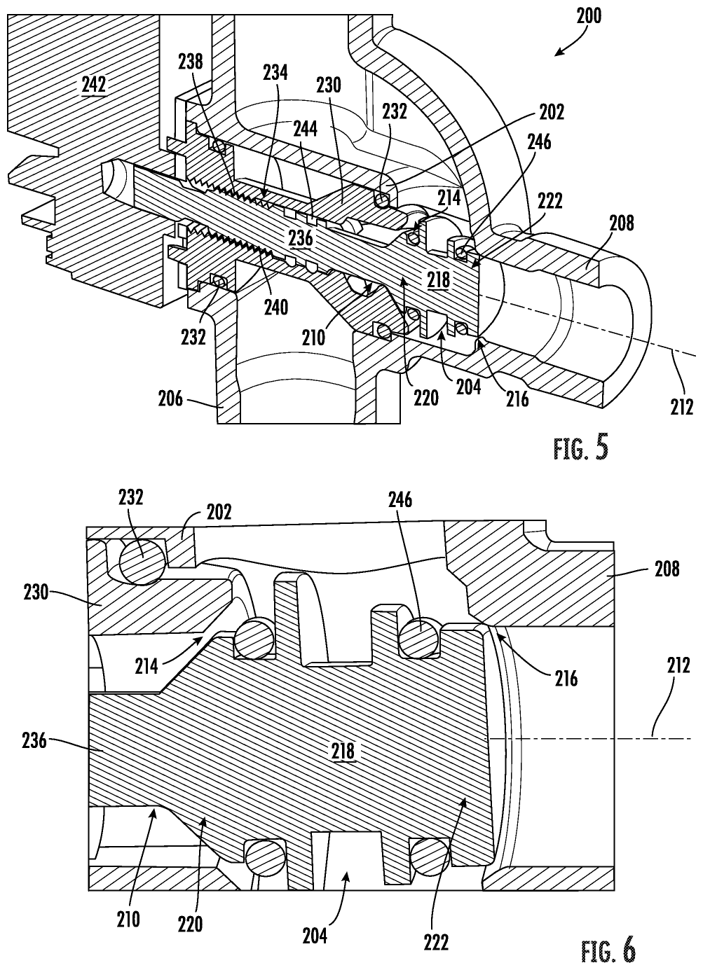

Notably, mixing valve 200 further includes features for adjusting the portions of hot and cold water flowing through mixing chamber 204. In this regard, as best illustrated in FIGS. 4 and 5, mixing valve 200 includes a plunger valve 210 that is movable along a translation axis 212 to selectively restrict or otherwise regulate the flow area through a hot water inlet orifice 214 and a cold water inlet orifice 216. According to the illustrated embodiment, plunger valve 210 includes a plunger head 218 that is positioned within mixing chamber 204 and defines a hot water sealing portion 220 and an opposite cold water sealing portion 222. In addition, hot water inlet orifice 214 and cold water inlet orifice 216 are positioned on opposite sides of plunger head 218 relative to the translation axis 212. In this manner, moving plunger valve 210 in one direction (e.g., to the right as shown in FIG. 6) will cause plunger head 218 to restrict the flow of cold water through cold water inlet orifice 216 while increasing the flow of hot water through hot water inlet orifice 214. Similarly, moving plunger valve 210 in the other direction (e.g., to the left as shown in FIG. 6) will cause plunger head 218 to restrict the flow of hot water through hot water inlet orifice 214 while increasing the flow of cold water through cold water inlet orifice 216. Although an exemplary valve configuration as shown, it should be appreciated that aspects of the present subject matter may apply to other valve types and configurations. For example, according to alternative embodiments, mixing valve 200 may include more than one restriction device for independently restricting the flow of hot water in the flow of cold water.

Mixing valve 200 may include any suitable mechanism or device for moving plunger valve 210 along the translation axis 212 within mixing chamber 204. For example, according to the illustrated embodiment, mixing valve 200 includes a drive body 230 that is fixed within valve body 202 immediately upstream of hot water inlet orifice 214. Drive body 230 may include one or more drive body seals 232, such as O-rings, that are designed to prevent leaks and direct the flow hot water only through hot water inlet orifice 214. In addition, drive body 230 defines a central bore 234 through which a shaft 236 of plunger valve 210 is received. Drive body 230 further defines stationary threads 234 that protrude from an inner wall of central bore 234 and shaft 236 of plunger valve 210 defines complementary plunger threads 240 that engage stationary threads 238. In this manner, when plunger valve 210 is rotated, plunger threads 240 and stationary threads 238 engage each other and cause plunger valve 210 to move along the translation axis 212.

According to the illustrated embodiment, mixing valve 200 further includes a drive motor 242 that is operably coupled to plunger valve 210. In this regard, drive motor 242 may be a stepper motor that is configured for selectively rotating plunger valve 210 such that threads 238, 240 move plunger valve 210 along the translation axis 212 to regulate the flow of hot water and the flow of cold water as desired. As used herein, “motor” may refer to any suitable drive motor and/or transmission assembly for rotating a system component. For example, drive motor 242 may be a brushless DC electric motor, a stepper motor, or any other suitable type or configuration of motor. Alternatively, for example, drive motor 242 may be an AC motor, an induction motor, a permanent magnet synchronous motor, or any other suitable type of AC motor. In addition, drive motor 242 may include any suitable transmission assemblies, clutch mechanisms, or other components.

According to the illustrated embodiment, mixing valve 200 may further include additional seals for improving flow regulation and reducing leaks within mixing valve 200. In this regard, for example, mixing valve 200 includes one or more shaft seals 244 that are positioned around shaft 236 within central bore 234, e.g., to prevent water from leaking out of mixing valve 200 through central bore 234. In addition, mixing valve may include one or more head seals 246 that are positioned around hot water sealing portion 220 and cold water sealing portion 222 of plunger head 218, e.g., for improving flow regulation through hot water inlet orifice 214 and cold water inlet orifice 216, respectively. According to the illustrated embodiment, shaft seals 244 and head seals 246 are rubber O-rings. However, alterative sealing mechanisms or devices may be used while remaining within the scope of the present subject matter.

According to exemplary embodiments, mixing valve 200 may be operatively coupled with any suitable controller, such as controller 150, for regulating the position of plunger valve 210 and the temperature of the flow of mixed water within mixed water conduit 132. In this regard, as explained above, mixing valve 200 may further include a temperature sensor 136 that is operably coupled with mixed water conduit 132 for detecting a temperature of the flow of mixed water. Controller 150 may then selectively operate drive motor 242 to rotate plunger valve 210 to maintain a desired temperature.

Now that the construction of mixing valve 200 has been described, an exemplary method 300 of operating a mixing valve will be described. Although the discussion below refers to the exemplary method 300 of operating mixing valve 200, one skilled in the art will appreciate that the exemplary method 300 is applicable to the operation of a variety of other mixing valve for use in any suitable application. In exemplary embodiments, the various method steps as disclosed herein may be performed by controller 150 or a separate, dedicated controller.

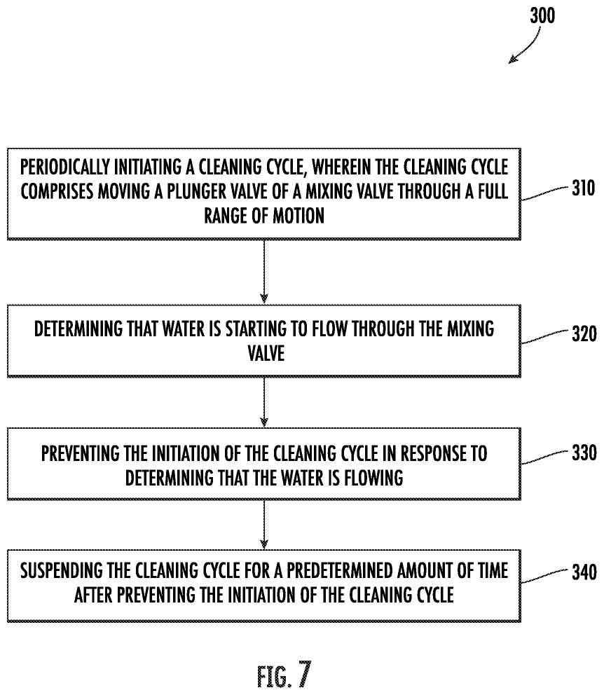

Referring now to FIG. 7, method 300 includes, at step 310, periodically initiating a cleaning cycle of a mixing valve. In this regard, continuing the example from above, mixing valve 200 may have a tendency to build up hard water scale or mineral deposits at locations throughout mixing valve 200, particularly in those regions exposed to hotter water temperatures. Aspects of the present subject matter are directed to methods of operation which reduce this build up and ensure long-term, reliable performance of mixing valve 200. Although an exemplary cleaning cycle is described herein, it should be appreciated that variations and modifications to the cleaning cycle may be made while remaining within the scope of the present subject matter. According to exemplary embodiments, controller 150 or another dedicated controller may implement method 300.

In general, the mixing valve cleaning cycle may include any movement of plunger valve 210 that is not necessarily intended to regulate the temperature of water within mixing valve 200, but is instead intended to scrub or remove buildup within mixing valve 200. For example, according to an exemplary embodiment, the cleaning cycle includes moving plunger valve 210 of mixing valve 200 through a full range of motion. In this regard, referring briefly to FIG. 6, the full range of motion may include moving plunger valve 210 to a full cold position (e.g., where plunger valve 210 is at a farthest left position) and to a full hot position (e.g., where plunger valve 210 is a farthest right position).

Notably, moving plunger valve 210 through this cleaning cycle may cause various seals or O-rings, such as shaft seals 244 and head seals 246 to rub against engaging services and orifices to periodically remove deposits before harmful build-up occurs. Although the cleaning cycle is described herein as being one full stroke of plunger valve 210, it should be appreciated that according to alternative embodiments, other cleaning actions may be implemented. For example, plunger valve 210 may be cycled through several back-and-forth ranges of motion, may be oscillated at high frequency when one or more seals are located in regions having increased potential for scale build-up, etc.

This cleaning cycle may generally be performed at any time and frequency as needed for a particular application to keep build-up at a minimum. In this regard, for example, the cleaning cycle may be repeated at a predetermined time period or interval. For example, the cleaning cycle may be performed at least once a week, at least once every other day, at least once per day, every 12 hours, every four hours, every one hour, every 30 minutes, every 10 minutes, or at any other suitable interval. Notably, this interval may be selected based on a variety of parameters, such as operating conditions of mixing valve 200, the hardness of water, water temperatures, detected buildup, or any other suitable parameters. According still other embodiments, controller 150 may be configured for monitoring temperatures, water conditions, and other parameters, and using this data to automatically determine when a cleaning cycle is desirable, and then initiating such a cleaning cycle.

The duration of the cleaning cycle may generally be any suitable amount of time necessary to clean surfaces or remove deposits. This cleaning duration may be fixed or may vary depending on anticipated build up. For example, according to exemplary embodiments, the cleaning cycle may take between about 1 second and 5 minutes, between about 10 seconds and 3 minutes, between about 20 seconds and 1 minute, or about 30 seconds. Other cleaning cycle durations are possible and within scope of the present subject matter.

Notably, because plunger valve 210 is moved during a cleaning cycle, the output temperatures provided through mixed water conduit 132 will vary if water is supplied during the cleaning cycle. Therefore, according to exemplary embodiments, it may be desirable to prevent or otherwise not initiate the cleaning cycle when it is desirable to maintain the output temperature of mixing valve 200. In other words, it may be desirable to prevent the initiation of cleaning cycles when mixing valve 200 is supplying water to a user, e.g., via a water consuming device 114. Accordingly, aspects of the present subject matter are directed generally to detecting when a user is consuming water and adjusting the cleaning schedules in response to such use.

Specifically, step 320 includes determining that water is starting to flow through the mixing valve. For example, continuing example above, mixed conduit temperature sensor 136 may be used to measure a temperature of the water flowing through mixed water conduit 132 and cold water inlet temperature sensor 138 may be used to measure a temperature of the water flowing through cold water supply. By monitoring the water temperatures, controller 150 may determine whether water is being supplied through mixed water conduit 132. For example, controller 150 may determine that water is starting to flow through mixing valve 200 if the mixed water temperature is not a substantially constant. In this regard, if there is variability in the temperature of water within mixed water conduit 132, it may be presumed that water is being consumed by the user. It should be appreciated that the level of variability that triggers controller to suspend a cleaning cycle may vary depending on particular application while remaining within the scope of the present subject matter.

According to exemplary embodiments, determining that water is starting to flow through the mixing valve includes measuring a mixed temperature of the water in a mixed water conduit and/or an inlet temperature of the water in the cold water inlet conduit, and determining that a rate of change of the mixed temperature exceeds a first threshold and a rate of change of the inlet temperature exceeds a second threshold, e.g., to determine whether these temperatures are changing rapidly or are not substantially constant. The first threshold and the second threshold may be the same or different, and these rate of change thresholds may vary according to exemplary embodiments. For example, the first and second thresholds may be between about 1 and 20° F./sec, between about 2 and 10° F./sec, or about 5° F./sec. It should be appreciated that these thresholds are only exemplary, and any other thresholds or suitable methods for detecting the flow of water within the mixed water conduit may be used while remaining within the scope of the present subject matter.

Step 330 may include preventing the initiation of the cleaning cycle in response to determining that the water is flowing through the mixed water conduit 132. In this regard, if a scheduled cleaning cycle arises, controller 150 may prevent or not initiate that cleaning cycle in response to determining that water is being supplied to the user. Notably this may prevent dangerous situations such as providing scalding water to the user or providing water that results in appliance performance degradation and consumer dissatisfaction. Step 340 may include suspending the cleaning cycle for a predetermined amount of time after preventing the initiation of the cleaning cycle. In this regard, for example, controller 150 may register that a cleaning cycle still needs be performed but may wait until the user has finished using the water before initiating that cleaning cycle. It should be appreciated that controller 150 may be programmed to facilitate any suitable schedule adjustment as needed depending on the application.

FIG. 7 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 300 are explained using mixing valve 200 as an example, it should be appreciated that these methods may be applied to the operation of any suitable mixing valve.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A mixing valve for a water heater appliance, the mixing valve comprising:
a valve body that defines a mixing chamber;
a hot water inlet conduit providing fluid communication between the mixing chamber and a hot water supply;
a cold water inlet conduit providing fluid communication between the mixing chamber and a cold water supply;
a plunger valve mounted within the valve body, the plunger valve being moveable along a translation axis to regulate the flow of water from the hot water inlet conduit and the cold water inlet conduit;
a drive motor operably coupled to the plunger valve for selectively moving the plunger valve; and
a controller in operative communication with the drive motor, the controller being configured for:
periodically initiating a cleaning cycle, wherein the cleaning cycle comprises moving the plunger valve through a full range of motion.

2. The mixing valve of claim 1, wherein the controller is further configured for:
determining that water is starting to flow through the mixing valve; and
preventing the initiation of the cleaning cycle in response to determining that the water is flowing.

3. The mixing valve of claim 2, wherein determining that water is starting to flow through the mixing valve comprises:
measuring at least one of a mixed temperature of the water in a mixed water conduit or an inlet temperature of the water in the cold water inlet conduit; and
determining that a rate of change of the mixed temperature exceeds a first threshold and a rate of change of the inlet temperature exceeds a second threshold.

4. The mixing valve of claim 2, wherein the controller is further configured for:
suspending the cleaning cycle for a predetermined amount of time after preventing the initiation of the cleaning cycle.

5. The mixing valve of claim 1, wherein moving the plunger valve through the full range of motion comprises moving the plunger valve to a full hot position and a full cold position.

6. The mixing valve of claim 1, wherein the cleaning cycle is performed in less than 30 seconds.

7. The mixing valve of claim 1, wherein periodically initiating the cleaning cycle comprises:
initiating at least one cleaning cycle per day when the water is not flowing through the mixing valve.

8. The mixing valve of claim 1, wherein periodically initiating the cleaning cycle comprises:
initiating at least one cleaning cycle per hour when the water is not flowing through the mixing valve.

9. The mixing valve of claim 1, wherein the mixing valve further comprises:
a drive body mounted within the valve body, the plunger valve being mounted within the drive body such that it is movable along the translation axis.

10. The mixing valve of claim 9, wherein the plunger valve defines plunger threads and the drive body defines stationary threads, the plunger threads and the stationary threads engaging each other to move the plunger valve along the translation axis as the plunger valve is rotated.

11. The mixing valve of claim 10, wherein the drive motor selectively rotates the plunger valve to move the plunger valve along the translation axis.

12. The mixing valve of claim 1, wherein the drive motor is a stepper motor.

13. A method of operating a mixing valve for a water heater appliance, the mixing valve comprising a plunger valve moveable along a translation axis to regulate a flow of water from a hot water inlet conduit and a cold water inlet conduit, the method comprising:
periodically initiating a cleaning cycle, wherein the cleaning cycle comprises moving the plunger valve through a full range of motion.

14. The method of claim 13, further comprising:
determining that water is starting to flow through the mixing valve; and
preventing the initiation of the cleaning cycle in response to determining that the water is flowing.

15. The method of claim 14, wherein determining that water is starting to flow through the mixing valve comprises:
measuring at least one of a mixed temperature of the water in a mixed water conduit or an inlet temperature of the water in the cold water inlet conduit; and
determining that a rate of change of the mixed temperature exceeds a first threshold and a rate of change of the inlet temperature exceeds a second threshold.

16. The method of claim 13, further comprising:
suspending the cleaning cycle for a predetermined amount of time after preventing the initiation of the cleaning cycle.

17. The method of claim 13, wherein moving the plunger valve through the full range of motion comprises moving the plunger valve to a full hot position and a full cold position.

18. The method of claim 13, wherein the cleaning cycle is performed in less than 30 seconds.

19. The method of claim 13, wherein periodically initiating the cleaning cycle comprises:
initiating at least one cleaning cycle per day when the water is not flowing through the mixing valve.

20. The method of claim 13, wherein periodically initiating the cleaning cycle comprises:
initiating at least one cleaning cycle per hour when the water is not flowing through the mixing valve.
